(19) United States
(12) Patent Application Publication
(10) Pub. No.: US 2006/0022525 A1
(43) Pub. Date: Feb. 2, 2006

(54) Remote sensing regulated voltage power supply

(76) Inventor: Clet Antoine Landry, Katy, TX (US)

Correspondence Address: E. Eugene Thigpen;Petroleum Geo-Services, Inc., P.O. Box 42805, Houston, TX, 77242-2805, US

(21) Appl. No.: 10/954,066

(22) Filed: Sep. 29, 2004

Related U.S. Application Data
(60) Provisional application No. 60/598,181, filed on Aug. 2, 2004.

(51) Int. Cl. H02J 1/00

(52) U.S. Cl. 307/86

(57) ABSTRACT

A remote sensing, regulated voltage power supply system is disclosed. The power includes a controllable output power supply having a control input terminal. An output of the power supply is related to a voltage signal applied to the control input terminal. Power supply lines connect an electrical load to a power output of the power supply. A voltage sensing element is coupled to at least one of the power supply lines proximate the electrical load. A buffer circuit is coupled between the voltage sensing element and the control input terminal. In one embodiment, the buffer circuit includes a high impedance voltage comparator disposed proximate the power supply and coupled at one input to a voltage sensing. The voltage sensing line extends from the voltage sensing element to the voltage comparator.

### CROSS-REFERENCE TO RELATED APPLICATIONS

This application claims priority under 35 U.S.C. 119(e) to U.S. provisional application Ser. No. 60/598,181, filed on Aug. 2, 2004, entitled “Remote Controlled Regulated Voltage Power Supply”, the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of controlled voltage power supplies. More specifically, the invention relates to power supplies having capability to sense voltage applied near an electrical load energized by the power supply, where the load is located along a substantial length of electrical conductor from the power supply and is subject to substantial change.

2. Background Art

Typical direct current (“DC”) power supplies having a regulated output voltage operate by measuring voltage at or near the output terminals of the power supply. An amount of current generated by the power supply, and conducted to an electrical load, is adjusted so that the measured voltage remains substantially constant, irrespective of changes in the load.

In some applications there is a relatively long electrical conductor between the power supply and the electrical load. One such application is marine seismic sensor systems (called “streamers”). A marine seismic sensor streamer includes a plurality of seismic sensors (typically hydrophones) positioned at spaced apart locations along a strength member or cable. The cable is ultimately fastened to a seismic survey vessel, which tows the streamer through the water. The sensors on the streamer generate electrical signals corresponding to detected seismic energy. Individual ones of the seismic sensors, and/or groups of the seismic sensors, are electrically connected to signal processing and telemetry modules. The modules are also positioned at spaced apart locations along the cable. The signal processing and telemetry modules serve to amplify, condition and format the electrical signals from each of the sensors into one or more types of signal telemetry. The signal telemetry may be optical (wherein the modules include one or more electrical to optical converters), or may be electrical. Irrespective of the particular circuits used on any of the modules, the streamer must include one or more electrical conductors to transmit electrical power to the modules, and must do so over a substantial distance. Consequently, there may be a substantial difference between the voltage at the power input to the modules and the output voltage of the power supply. It has been observed that many modules operate at less than the optimum because of this voltage drop. Furthermore, during operation of typical marine seismic streamer systems, individual modules may switched on and off, causing changes in the electrical load ultimately applied to the power supply on board the seismic vessel.

Another consideration in marine seismic streamer systems is the need to keep cable drag in the water to a minimum. Some types of streamer systems include a plurality of streamers coupled to devices used to maintain the lateral spacing and relative axial position between the streamers. A cable system used to carry electrical power and telemetered data between the seismic vessel and the forward end of a single streamer, or the streamer positioning device in multiple streamer arrangements, is referred to as a “lead in umbilical.” To reduce the drag caused by the lead in umbilical, the diameter of the umbilical has been reduced, in some implementations, by using optical telemetry. Reducing the diameter of electrical power conductors in the umbilical would enable reduction in the diameter of the umbilical and further reduction in the umbilical drag. Limitations of known power supply systems have made substantial reduction in umbilical power conductor diameter impractical.

One possible implementation of using power supply systems known in the art to improve voltage regulation along a streamer and to reduce electrical conductor size includes providing a DC to DC converter at the end of the umbilical most distant from the seismic vessel, which reduces the current flow requirement along the umbilical. It is believed that such a configuration would decrease system reliability because the DC to DC converter would necessarily be disposed in the water. Therefore, the foregoing implementation is believed to be impractical.

There exists a need for a regulated DC power supply that is capable of maintaining precise voltage under variable load conditions at a substantial load distance from the power supply, while minimizing the required diameter or size of electrical conductors connecting the power supply to the load.

### SUMMARY OF THE INVENTION

One aspect of the invention is a remote sensing, regulated voltage power supply system. A power supply according to this aspect of the invention includes a controllable output power supply having a control input terminal. An output of the power supply is related to a voltage signal applied to the control input terminal. Power supply lines connect an electrical load to a power output of the power supply. A voltage sensing element is coupled to at least one of the power supply lines proximate the electrical load. A buffer circuit is coupled between the voltage sensing element and the control input terminal. In one embodiment, the buffer circuit includes a high impedance voltage comparator disposed proximate the power supply and coupled at one input to a voltage sensing element. The voltage sensing line extends from the voltage sensing element to the voltage comparator.

In another embodiment, the voltage sensing element comprises an analog to digital converter coupled to a digital telemetry transmitter. The transmitter is coupled to the power supply lines proximate the load. A digital telemetry receiver is coupled to the power supply lines proximate the power supply. An output of the receiver provides a voltage measurement signal operatively coupled to the voltage control input terminal.

Another aspect of the invention is a marine seismic sensing system. A system according to this aspect of the invention includes a marine seismic streamer lead in coupled at one end to a seismic vessel. The lead in is coupled at the other end to at least one seismic sensor streamer. The streamer includes a plurality of signal processing modules disposed along the streamer at spaced apart locations. A controllable output power supply is disposed on the seismic vessel. The power supply includes a control input terminal. An output of the power supply is related to a voltage signal applied to the control input terminal. Power supply lines connect power input terminals of the modules to a power output of the power supply. A voltage sensing element is coupled to the power supply lines proximate one of the modules. A buffer circuit is coupled between the voltage sensing element and the voltage control input terminal.

Other aspects and advantages of the invention will be apparent from the following description and the appended claims.

### BRIEF DESCRIPTION OF DRAWINGS

FIG. 1 shows a marine seismic survey system in which a power supply according to the invention may be used.

FIG. 2 shows a functional block diagram of one embodiment of a power supply according to the invention.

FIG. 3 shows an alternative embodiment of a remote voltage sensing unit and buffer.

### DETAILED DESCRIPTION

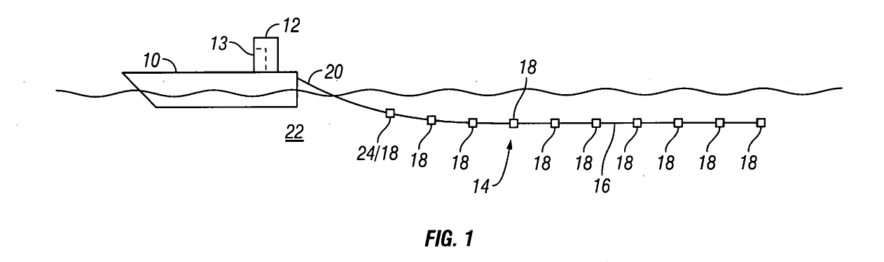

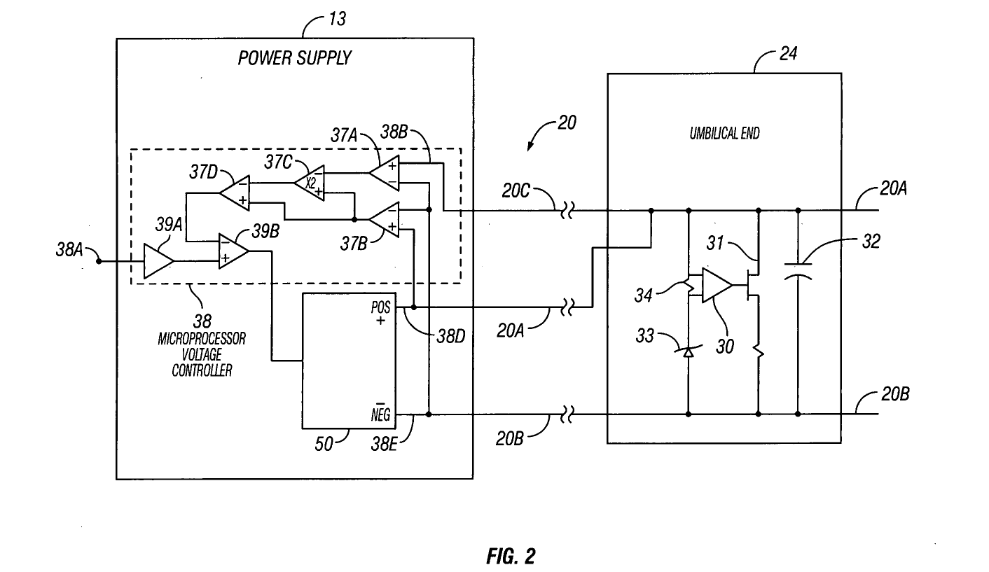

FIG. 1 shows a marine seismic survey system which may include a power supply according to an embodiment of the invention. In FIG. 1, a seismic vessel 10 tows one or more marine seismic sensor streamers 14 in a body of water 22. Only one streamer is shown in FIG. 1 for clarity of the illustration, but the number of streamers in any implementation is not a limitation on the scope of the invention. The seismic vessel 10 includes recording and navigation equipment 12 of types well known in the art for recording signals from one or more seismic sensors (not shown separately in FIG. 1), determining the position at any time of the vessel 10 and the seismic sensors (not shown) and for controlling the timing of actuation of a seismic energy source (not shown in FIG. 1). The recording equipment 12 includes a regulated output direct current power supply 13 (which will be explained below with reference to FIG. 2) for supplying power to various modules, to be explained below, on the streamer.

The streamer 14 includes a plurality of modules 18 positioned along a load-bearing strength member or cable 16 at spaced apart locations. The streamer 14 typically includes a telemetry signal line (not shown separately in the Figures) which may be one or more optical fibers or one or more electrical conductors, or both, depending on the type of telemetry used in any embodiment of the streamer 14. The streamer 14 is electrically and telemetrically coupled to the seismic vessel 10 by a lead-in umbilical line 20. The lead in umbilical line 20 will typically include a plurality of electrical conductors, shown in FIG. 2 as electrical conductors 20A and 20B to provide electrical power from the power supply 13 to the various modules 18 on the streamer 14. The modules 18 may include various circuits (not shown separately) known in the art for amplifying, filtering and formatting for telemetry electrical signals generated by seismic sensors (not shown separately in FIG. 1) in response to detected seismic energy. The modules 18 may include circuits to convert analog electrical signals from the sensors (not shown) into digital form for inclusion in the telemetry. The actual circuitry used in any one or more of the modules 18 is not a limitation on the scope of the invention, however. For purposes of describing the invention, it is only important that the modules 18 require a regulated voltage to energize the various circuits therein.

A first one of the modules 18 may include a remote voltage sensing unit 24. The remote voltage sensing unit 24 may also be disposed separately from the first one of the modules 18. Typically, the remote voltage sensing unit 24 is disposed at the end of the lead in umbilical line (“lead in”) 20 opposite the end coupled to the seismic vessel 10. The remote voltage sensing unit 24 will be explained in more detail below with reference to FIG. 2. In a first embodiment the remote sensing unit comprises an electrical connection. In a second embodiment the remote sensing unit may comprise an analog to digital converter.

An example embodiment of a remote sensing voltage controlled power supply 13 according to one aspect of the invention is shown in FIG. 2. A microprocessor-based voltage controller 38 is disposed within or proximate the power supply 13. The microprocessor voltage controller 38 can be any type of digital voltage controller known in the art. The power supply 13 is typically located aboard the seismic vessel 10. In the particular embodiment of the voltage controller, the voltage at the streamer cable modules is sensed and applied to the voltage controller 38 through a buffer, which in a first embodiment comprises a high input impedance operational amplifier included in voltage controller 38. The means for applying the voltage level remotely sensed near the location of the cable modules comprises an electrical conductor 20C extending between the location of the cable sensors and the voltage controller 38. The purpose of the buffer circuit is to provide a voltage measurement path between the load end of the lead in umbilical 20 and the control input terminal 38B to the voltage controller 38 such that a control signal (whether analog or digital) imparted to the control input terminal 38B is substantially directly related to the voltage at the load end of the lead in umbilical 20 and is substantially unaffected by voltage drop along the lead in umbilical 20.

The voltage that it is desired to supply to the cable modules 18 is selected by an operator and applied at the input at terminal 38A. For example, if it is desired to apply +50 volts at the load end of electrical conductor 20A and −50 volts at the load end of electrical conductor 20B, the magnitude of the voltage applied to the modules 18 will be 100 volts.

FIG. 2 illustrates one embodiment of a microprocessor based voltage controller 38. An input signal equal to the desired output voltage to be applied to the cable modules 18, which in the example discussed herein may be 100 volts, is applied to the input terminal 38A of the microprocessor based voltage controller 38. The operator set input may then be buffered by unity gain amplifier 39A, and then applied to the positive (+) terminal of operational amplifier (comparator) 39B. For reasons explained below the input to the negative (−) terminal of operational amplifier 39B represents the actual voltage applied to the streamer modules. If the signal level applied to the negative (−) terminal of comparator 39B is less that the operator set input signal applied to input terminal 38A, the output of comparator 39B will increase. If this signal level applied to the negative (−) terminal of comparator 39B is greater than the operator set input level applied to input terminal 38A, the output of the comparator 39B will decrease.

The output of comparator 39B is applied to power amplifier 50, which generates a DC voltage output between terminals 38D and 38E in response to the magnitude of the output of comparator 39B, but with an amplified current capability, so that power amplifier 50 is capable of supplying the needed current to the streamer modules 18 at the operator selected voltage level applied to input terminal 38A. As explained previously there will be a significant voltage drop along current supply line 20A between the positive output terminal 38D of voltage amplifier 50 and the cable modules 18 on streamer cable 14, and a further voltage drop along current return line 20B between the cable modules and the negative terminal 38E of the voltage amplifier 50. The output of comparator 39B controls power amplifier 50 so that the output voltage of voltage amplifier 50 is of a magnitude so that the voltage actually applied across the cable modules 14 is the desired voltage magnitude, That is, the magnitude of the output voltage from voltage amplifier 50 will equal the voltage drop in electrical conductor 20A plus the voltage drop in electrical conductor 20B plus the voltage applied across cable modules 14.

Accordingly, the output voltage at the positive terminal output to the power amplifier 50 will be (+V+y), where +V is the positive voltage magnitude applied to the cable modules, and y represents the voltage drop between the power amplifier positive output 38D and the cable modules. The voltage at the negative output terminal 38E of power amplifier 50 will be (−V−y), where −V is the voltage at the negative voltage magnitude applied to the streamer modules, and y represents the voltage drop between the cable modules and the power amplifier negative output terminal 38E. Note that it is assumed that the voltage drop between the power amplifier positive output 38D and the cable modules and the voltage drop between the cable modules and the power amplifier negative output 38E will be substantially the same.

Comparator 37B, which may be an operational amplifier, has its positive input terminal connected to the positive output terminal 38D of power amplifier 50, and its negative input terminal connected to the negative output terminal 38E of power amplifier 50, so that the output of comparator 37B will represent (+2V+2y). As explained above, comparator 37A has its positive input terminal 38B connected via electrical conductor 20C to electrical conductor 20A substantially at the positive power input of the cable modules, so that the voltage applied to the positive input terminal of comparator 37A represents the positive voltage actually supplied to cable modules 18. The negative input terminal of comparator 37A is connected to the negative output terminal 38E of power amplifier 50, so that the output of comparator 37A represents [+V−(−V−y)], which may be rewritten as (+2V+y). The output of comparator 37A is applied to the positive input terminal of comparator 37C and the output of comparator 37B is applied to the negative input terminal of comparator 37C. Comparator 37C may be an operational amplifier having a gain of two (×2), so that the output of comparator 37C will be equal to +2y, which is the voltage drop on conductor 20A between the power amplifier positive output 38D and the cable modules plus the voltage drop on conductor 20B between the cable modules and the power amplifier negative output 38E.

The output of ×2 comparator 37C is applied to the negative input terminal of comparator 37D, which may also be an operational amplifier, and the output of comparator 37B is applied to the positive input terminal of comparator 37D, so that the output of comparator 37D will be equal to +2V, the magnitude of the voltage applied across cable modules 18 by electrical conductors 20A and 20B. The output of comparator 37D is applied to the negative input of operational amplifier 39B. It will be understood by those of ordinary skill in the art that comparator 39B will control power amplifier 50 so that the voltage actually applied across the cable modules 18 and remotely sensed and applied to comparator 37A positive terminal via electrical conductor 20C, will be maintained at substantially the same magnitude as the operator selected voltage level applied at input terminal 38A.

As shown in FIG. 2, a circuit frequently referred to as a “crowbar” may be applied across power lines 20A and 20B near the end of the umbilical cable 20 most distant from the vessel 12 (the load end). The “crowbar” circuit comprises an operational amplifier 30 coupled across the power supply lines 20A, 20B through zener diode 33. The input terminals of the operational amplifier 30 are shunted by resistor 34. Output of the operational amplifier 30 drives transistor 31. The purpose of the crowbar circuit is to clamp voltage spikes that may occur in the power supply lines 20A, 20B as the electrical load on the power supply 13 changes during operation.

In the present embodiment, an electrolytic capacitor 32 may be coupled across the voltage supply lines 20A, 20B. It has been determined through experimentation using the arrangement shown in FIG. 2 that when modules (18 in FIG. 1) are switched on during operation of the streamer (14 in FIG. 1) the momentary increase in electrical load my cause a voltage drop of a magnitude sufficient to cause one or more of the modules (18 in FIG. 1) to fail to actuate. Having a localized store of electrical charge at the load end of the lead in 20 reduces the possibility of such momentary load increase causing actuation failure.

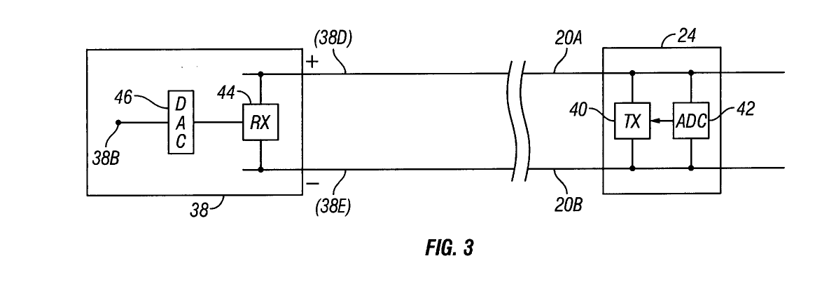

Another embodiment of a buffer for applying the voltage at the streamer cable modules to voltage controller 38 is shown schematically in FIG. 3. At the load end of the power supply lines 20A, 20B, and typically in the remote sensing unit 24, an analog to digital converter (ADC) 42 is coupled across the power supply lines 20A, 20B so as to generate digital words corresponding to the voltage across the power supply lines 20A, 20B proximate the electrical load (modules 18). Output of the ADC 42 may be coupled to a telemetry transmitter (TX) 40, which formats the digital words for communication along a signal line (which may be an optical fiber, or as shown in FIG. 3, may include the power supply lines 20A, 20B. In some embodiments, the telemetry transmitter 40 may be coupled to a telemetry unit (not shown) used to communicate signals from the various seismic sensors (not shown separately in the Figures) to the seismic vessel (10 in FIG. 1).

In the present embodiment, a telemetry receiver 44 may be coupled across the power supply lines 20A, 20B proximate the power supply (13 in FIG. 2). In other embodiments, the telemetry receiver 44 may be coupled to an optical fiber (not shown). Output of the telemetry receiver 44 may be coupled to a digital to analog converter (DAC) 46 to provide an analog voltage control signal output. The analog voltage control signal output may be coupled to the voltage control input terminal 38B of the voltage controller and used substantially as explained with respect to the embodiment described with reference to FIG. 2. The present embodiment of the buffer circuit, just as the previous embodiment of the buffer circuit, provides a voltage signal proximate the power supply that corresponds to the voltage extant proximate the electrical load. Thus, changes in electrical load, such as switching on and off various ones of the modules (18 in FIG. 1) can be compensated by controlling the output of the power supply 13 so as to maintain a selected voltage at the load end of the lead in (20 in FIG. 1).

Embodiments of a power supply according to the invention may provide improved voltage regulation under variable load conditions where there must be a relatively long distance between a power supply and an electrical load, and where it is important that the diameter or thickness of the power supply lines extending from the power supply to the load be minimized. A seismic sensor system using a power supply according to the invention may have improved performance of remote signal processing and telemetry modules, while having the ability to use smaller diameter electrical conductors on the lead in umbilical than is possible using power supplies previously known in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A remote sensing, regulated-voltage power supply system, comprising:
a controllable output power supply having a control input terminal, an output of the power supply controlled in response to a voltage signal applied to the control input terminal;
power supply lines connecting an electrical load to a power output of the power supply;
a voltage sensing element to at least one of the power supply lines proximate the load; and
a buffer circuit coupled between the voltage sensing element and the control input terminal.

2. The power supply of claim 1 further comprising a clamping circuit coupled between the electrical load and the power supply lines.

3. The power supply of claim 1 further comprising an electrical charge storage device coupled to the power supply lines proximate the electrical load.

4. The power supply of claim 3 wherein the electrical charge storage device comprises an electrolytic capacitor.

5. The power supply of claim 1 wherein the buffer circuit comprises an operational amplifier coupled at one input terminal thereof to one end of a voltage sensing line, the voltage sensing line coupled at its other end to one of the power supply lines proximate the electrical load.

6. The power supply of claim 1 wherein the buffer circuit comprises an analog to digital converter coupled to the power supply lines proximate the load, a telemetry transmitter coupled to an output of the analog to digital converter, and a telemetry receiver disposed proximate the power supply, an output of the telemetry receiver operatively coupled to the control input terminal.

7. A marine seismic sensing system, comprising:
a marine seismic streamer lead in umbilical coupled at one end to a seismic vessel, the lead in coupled at the other end to at least one seismic streamer, the streamer including a plurality of signal processing modules disposed along the streamer at spaced apart locations; and
a controllable output power supply disposed on the seismic vessel, the power supply including,
a controllable output power supply having a control input terminal, an output of the power supply controlled in response to a voltage signal applied to the control input terminal,
power supply lines connecting power input terminals of the modules to a power output of the power supply,
a voltage sensing element coupled to at least one of the power supply lines proximate one of the modules, and
a buffer circuit coupled between the voltage sensing element and the control input terminal.

8. The system of claim 7 further comprising a clamping circuit coupled between the electrical load and the power supply lines.

9. The system of claim 7 further comprising an electrical charge storage device coupled to the power supply lines proximate the electrical load.

10. The system of claim 9 wherein the electrical charge storage device comprises an electrolytic capacitor.

11. The system of claim 7 wherein the buffer circuit comprises an operational amplifier coupled at one input terminal thereof to one end of a voltage sensing line, the voltage sensing line coupled at its other end to one of the power supply lines proximate the electrical load.

12. The system of claim 7 wherein the buffer circuit comprises an analog to digital converter coupled to the power supply lines proximate the load, a telemetry transmitter coupled to an output of the analog to digital converter, and a telemetry receiver disposed proximate the power supply, an output of the telemetry receiver operatively coupled to the control input terminal.
